(19) United States
(12) Patent Application Publication
(10) Pub. No.: US 2013/0216194 A1
(43) Pub. Date: Aug. 22, 2013

(54) Controlling Differential Group Delay In Mode Division Multiplexed Optical Fiber Systems

(71) Applicant: OFS Fitel, LLC, (US)

(72) Inventor: Yi Sun, Suwanee, GA (US)

(73) Assignee: OFS FITEL, LLC, Norcross, GA (US)

(21) Appl. No.: 13/651,563

(22) Filed: Oct. 15, 2012

Related U.S. Application Data
(60) Provisional application No. 61/600,873, filed on Feb. 20, 2012.

(30) Foreign Application Priority Data
Feb. 24, 2012 (US) PCT/US12/26662

(51) Int. Cl. G02B 6/04; G02B 6/24

(52) U.S. Cl. 385/115; 29/428; 83/13

(57) ABSTRACT

It has been discovered that within a group of optical fibers produced by methods designed to produce low Differential Group Delay (DGD), some optical fibers will show a positive DGD while others will show a negative DGD. That recognition allows optical fibers with excessive DGD to be combined in pairs, or other configurations, to produce transmission spans in which a positive (or negative) DGD partial span is compensated by a partial span of fiber with a negative (or positive) DGD.

Pairs of optical fibers with positive and negative DGD coefficients respectively may be deliberately produced and assembled in a cable in a concatenated fashion to produce reduced overall DGD in long transmission spans.

### RELATED APPLICATIONS

This application claims priority from U.S. Provisional Application Ser. No. 61/600,873 filed Feb. 20, 2012, and PCT PCT/US12/26662, filed Feb. 24, 2012.

### FIELD OF THE INVENTION

This invention relates to transmission of optical signals in optical fibers. More specifically it relates to mode division multiplexing of optical signals in a single optical fiber.

### BACKGROUND OF THE INVENTION

(Parts of the following section may not be prior art.)

Mode-division multiplexing (MDM) is considered to be a key technology for increasing information transmission over optical fibers. This technology is sometimes referred to as Space Division Muliplexing (SDM). However, SDM connotes the use of separate transmission spaces, typically separate media, while MDM is a technology that uses a single medium, here a single optical fiber, for simultaneous transmission of parallel channels of information. Thus MDM is a true spatial multiplexing technology.

MDM may be implemented in a variety of schemes. Pure MDM would use simultaneous transmission of different optical signals using different coexisting modes, all at the same wavelength. However, another attractive approach is to use MDM to improve Dense Wavelength Division Multiplexing (DWDM) performance. It is known that as WDM channels are more closely spaced, non-linear interactions, like four wave mixing (FWM), increase. It has been discovered that these non-linear interactions are less severe between different propagating modes. Since using different modes for transmitting optical signals in adjacent channels reduces the adverse effects of non-linear interactions the channels may be more closely spaced in wavelength, thus increasing information capacity in a given DWDM system.

The main characteristic of an MDM system is a single waveguide propagating at least two optical modes, wherein each of the propagating modes is modulated with a different optical signal. As mentioned above the multiple modes may have the same wavelength, or may have closely spaced wavelengths as in DWDM. The optical fiber used in this system is referred to as an MDM optical fiber.

However, MDM in itself presents new issues. One of these is differential group delay (DGD), which undesirably broadens the WDM channels. This property is sometimes referred to as “skew”. It occurs because the distance a higher order mode travels to go from point A to point B along a waveguide is longer than for a fundamental mode or a lower order mode. This effect is well known.

It is desirable to have low skew, also referred to as the difference in group delay or differential group delay (DGD), between guided modes in MDM. If a crosstalk recovery technique such as MIMO is required, then large DGD will make cross-talk recovery more difficult to implement. Even in the absence of cross-talk recovery, excessively high skew in MDM may cause buffers in the serializer-deserializer chipset to be overrun, or may produce undesirable latency between channels.

It is a practical challenge for optical fiber cable designers to limit or reduce skew in a typical MDM optical fiber. This is due to a wide manufacturing distribution of fiber DGD values, due to long system reach, or due to higher inherent DGD variation in the fiber design as the number of guided modes increases from two to four, or up to ten. Thus new methods are needed to reduce the overall DGD of an MDM transmission span. In the description below the DGD of a given MDM fiber is expressed as a coefficient, in ps/m (or ns/km).

### STATEMENT OF THE INVENTION

I have discovered that within a group of optical fibers produced by methods designed to produce low DGD, some optical fibers will show a significant positive DGD while others will show a significant negative DGD. That recognition allows a new approach to the problem of DGD accumulation along a transmission span. Rather than discard fibers with significant DGD they can be combined in pairs, or other configurations, to produce transmission spans in which a positive (or negative) DGD partial span is compensated by a partial span of fiber with a negative (or positive) DGD.

The discovery that both positive and negative DGD coefficient are possible in otherwise useful and practical optical fibers leads to a major advance in MDM transmission. That advance is the deliberate production of pairs of optical fibers with positive and negative DGD coefficients respectively. Given an understanding of how to deliberately produce pairs of fiber with this property, fibers can be assembled in cables in a concatenated fashion to produce reduced overall DGD over long transmission spans.

### BRIEF DESCRIPTION OF THE DRAWING

FIG. 1 is a schematic diagram of a transmission span with a single pair of DGD compensated optical fibers;

FIG. 2 is a schematic diagram of a long transmission span with multiple pairs of DGD compensated optical fibers;

FIG. 3 is a refractive index profile showing typical parameters for one group of optical fiber designs that may be used to implement the invention; and

FIG. 4 is a plot of DGD vs wavelength for optical fibers propagating two modes, LP₀₁ and LP₁₁, showing two compensating pairs of fibers with index profiles shown in Table 1.

### DETAILED DESCRIPTION

The invention addresses Differential Group Delay DGD in MDM systems. Details of DGD and how it is measured, as well as other information relevant to MDM, may be found in co-pending application PCT/US12/26662, which is incorporated herein by reference. More details of generalized DGD measurement techniques may be found in H. Xu, B. S. Marks, L. Yan, C. R. Menyuk, and G. M. Carter, “A comparison of measurement techniques for differential group delay in a long-haul optical system,” 2004 OFC, and the cited references, which are incorporated herein by reference. More details of Mode Division Multiplexing may be found in U.S. Pat. No. 7,609,918, issued Oct. 27, 2009, which patent is incorporated herein by reference.

According to one embodiment of this invention transmission spans with reduced DGD are produced by selecting fibers from a manufactured distribution which include optical fibers that have a positive DGD coefficient and other optical fibers with a negative DGD coefficient. In the description below, negative DGD means that the higher order mode travels faster than the lower order mode, while positive DGD means that the higher order mode travels more slowly. These fibers are concatenated in one of a variety of ways to produce an overall DGD coefficient with mean DGD near or at 0 ps/m (or ns/km). This may be done to exactly cancel DGD for two modes at one wavelength, or to minimize the DGD over a wavelength window for two or more modes possibly using an algorithm, e.g. as minimizing the mean-squared error as one example.

With reference to FIG. 1, a first optical fiber partial span 11 is shown coupled to a second optical fiber partial span 12 to produce an overall transmission span 14. The optical fiber 11 has a positive DGD coefficient, and the optical fiber 12 has a negative DGD coefficient.

Recognizing that the accumulated DGD is dependent on transmission length L, the partial span length with positive DGD and the partial span length with negative DGD may be combined together in pairs according to:

Sₚ×Dₚ=Sₙ×Dₙ (1)

where Sₚ and Sₙ are partial span lengths in linear distance units for the positive and negative partial spans, and Dₚ and Dₙ are, respectively, the DGD coefficient of the positive DGD partial span and the DGD coefficient of the negative DGD partial span. It should be recognized that the absolute values of Dₚ and Dₙ are typically not equal, so that Sₚ and Sₙ are typically not equal.

It should also be understood that advantages of the invention may be realized if the equality above is only partial. That is, the overall transmission performance will be improved if there is any significant compensation in accumulated DGD. Preferably the compensation is such that the accumulated DGD over the transmission span, DGDₜ, is less than the maximum DGD of either span. This can be expressed as follows:

Sₚ×Dₚ=DGDₚ

Sₙ×Dₙ=DGDₙ

and

|DGDₜ|<|DGDₚ| or |DGDₙ| (2)

In the MDM system shown in FIG. 1, where a length of few mode fiber with positive (or negative) DGD and another length of few mode fiber with negative (or positive) DGD are concatenated to achieve a target net DGD value for the span, the DGD between different modes may cause a distributed noise due to distributed coupling. It is cross talk and causes a system penalty. If it is too severe in either time-domain spreading or amplitude or both, it increases the complexity of MIMO to recover it. The distributed noise is limited in the time window set by the maximum DGD of either the positive few mode fiber or negative few mode fiber in one span. Thus ideally the fiber lengths Sₚ and Sₙ are chosen so that

max(|Sₚ*Dₚ|,|Sₙ*Dₙ|)≦τ_{cross}^{max} (3)

and

DGDₜ≈0 (4)

where τ_{cross}^{max} is the maximum allowable time window for distributed cross talk. It is allowable to have some net span DGD in practice. It is also desirable to design the fiber to minimize distributed coupling coefficient and reduce the amplitude of the distributed coupling. With some degree of distributed coupling, DGD may no longer accumulate linearly, then the above equations may not be followed strictly, though in principle would still be the same. With some or severe distributed coupling, there may be additional nonlinear effects between different LP modes, in addition to those nonlinear effects that exist in single mode fiber with single LP mode. In that case it may be beneficial to compensate the accumulated DGD before demultiplexing at the receiver in order to minimize non-linear effects. In that embodiment the partial span 11 is long, but may have a low positive (or negative) DGD coefficient. Thus it accumulates DGD slowly, but over the long span has a relatively large accumulated DGD. The span 12 may then be made with a large negative (or positive) DGD coefficient. That allows span 12 to be considerably shorter than span 11 for complete equalization of DGD for the overall span.

To reduce accumulated DGD at specific points along a long transmission span, and possibly reduce unwanted intermodal effects, more than one pair of partial spans may be employed. This is illustrated in the embodiment of FIG. 2, which is a plot of accumulated DGD vs distance for a very long haul cable, nearly 1200 km. In this long cable the accumulated DGD at points along the length of the cable is minimized using pairs of partial spans as described by FIG. 1. The span represented in FIG. 2 has nine pairs of partial spans. The partial spans with a positive DGD coefficient are shown as solid lines 21 and the partial spans with a negative DGD coefficient are shown as dashed lines 22. The spans 21 and 22 are optically joined by, for example, standard optical fiber splices.

If the DGD compensation is not precisely zero, the case represented in FIG. 2, DGD may accumulate over the overall cable length. In this embodiment a final compensating span 25 eliminates the accumulated DGD over the overall span distance. This final compensating span may be relatively short, with a relatively high DGD coefficient. The deliberate accumulation of a modest amount of DGD over the span may be advantageous. Assume the deliberate accumulated DGD is negative (as in the example shown in FIG. 2. In that case it will be known that the final compensating span, 25, will be positive. If during the final assembly of the transmission span the residual negative DGD is measured, the final compensating span may be cut to the length that precisely compensates DGD in the overall span.

In FIG. 2, the points where the positive DGD and negative DGD spans are joined is indicated at 24. In a very long haul cable, these points may represent amplifiers.

The approach just described may be used particularly when, taking account of other transmission performance parameters, the transmission performance of the relatively high DGD coefficient fiber is inferior in other regards to the optical fiber used over the rest of the long haul.

The DGD slope of the positive DGD few mode fiber and negative DGD few mode fiber can be further chosen to be opposite so that the accumulated group delay compensation is achieved in a larger wavelength window. For effective MDM it is understood that fibers with four or even a higher number of LP modes, typically up to ten, may be designed according to the same principles. Improved two mode fibers may also be invented. They also may be beneficially combined according to the principles disclosed above.

According to another embodiment of the invention, optical fibers with deliberately positive DGD and deliberately negative DGD are produced by engineering the refractive index profile of the optical fibers.

A typical optical fiber refractive index profile includes a central core comprised mainly of silica with of index of refraction greater than that of undoped silica. The raised index of refraction of this region is usually produced by doping the silica with germania. The core shape can be described by the well known alpha profile, but may also include an on-axis “index dip” that typically results from preform fabrication processing related issues. The core alpha parameter is typically greater than 1, but less than 3. The central core may be surrounded by one or more trenches, with index of refraction less than that of undoped silica. Index of refraction within this “trench” region is approximately constant as a function of radius, although there may be regions of index transition at the inner and outer radius of the region where the index gradient with radius is not close to zero. The reduced index of refraction within the trench region is usually formed using silica doped with fluorine. The index profile in FIG. 3 shows two trenches, separated by an annular region of un-doped silica. The second trench may produce reduced bending loss but has negligible effect on DGD. The region at radius greater than the second trench is un-doped silica, but may include regions of increased index of refraction. The reduced index of refraction layer forming the trenches typically is achieved by fluorine doping, or by the presence of voids in the silica.

These deliberately tailored optical fibers are concatenated in one of a variety of ways as described earlier to produce an overall DGD coefficient with low mean DGD (preferably near 0 ps/m, or ns/km). Examples of suitable fiber designs with tailored DGD for use as described above are given in the following table. The design parameters, underlined, are referenced to those shown in FIG. 3.

TABLE 1

| | F0 | F1_P | F2_P | F2_N | F1_N |
|---|---|---|---|---|---|
| CORE | | | | | |
| center | 0.0118 | 0.0118 | 0.0118 | 0.0118 | 0.0118 |
| index | | | | | |
| dcc | | | | | |
| outer | 0.0024 | 0.0024 | 0.0024 | 0.0024 | 0.0024 |
| index | | | | | |
| dco | | | | | |
| alpha a | 1.619 | 1.719 | 1.619 | 1.619 | 1.619 |
| width | 7.12 | 7.12 | 7.12 | 6.84 | 6.55 |
| Wc | | | | | |
| TRENCH 1 | | | | | |
| index | −0.0038 | −0.0038 | −0.0041 | −0.0038 | −0.0038 |
| dt1 | | | | | |
| width | 5.32 | 5.32 | 5.32 | 5.11 | 4.89 |
| Wt1 | | | | | |
| CLADDING | | | | | |
| width | 16 | 16 | 16 | 16 | 16 |
| Wcl | | | | | |
| TRENCH 2 | | | | | |
| index | −0.0087 | −0.0087 | −0.0087 | −0.0087 | −0.0087 |
| dt2 | | | | | |
| width | 4.50 | 4.50 | 4.50 | 4.50 | 4.50 |
| Wt2 | | | | | |

FIG. 4 gives DGD data for the optical fibers represented in FIG. 3. FIG. 4 is a plot of DGD in ps/m vs wavelength showing group delay between LP₀₁ and LP₁₁ modes. Optical fiber F0 shows zero DGD at a wavelength of 1.55 microns, the nominal center wavelength in commonly employed DWDM systems. Optical fiber F1_P shows significant positive DGD over the wavelength band of interest in this example. To compensate for unwanted DGD a transmission span of optical fiber with negative DGD may be optically coupled with optical fiber F1_P. The data of FIG. 4 shows that at a wavelength of 1.58 microns an equal length of optical fiber F1_N will produce essentially zero DGD for the pair. Alternatively, the DGD in a length of F1_P optical fiber may be compensated using a longer length of optical fiber F2_N. From the data of FIG. 4, and using equation (1), for a 1000 meter transmission span operating at 1.58 microns, the DGD in a 500 meter partial span of F1_P may be compensated with a 500 meter partial span of F1_N. Alternatively, the 1000 meter transmission span operating at 1.58 microns, DGD in a 254 meter partial span of F1_P may be compensated paired with a 746 meter partial span of F2_N. Similar to F1_P, F_{—}2P can be compensated by F1_N or F2_N in the right length.

It will be understood by those skilled in the art that the DGD compensated optical fibers described above are adapted for use in MDM systems. These systems transmit optical signals using more then one optical mode. Examples of commonly used modes are LP₀₁, LP₁₁, LP₀₂, LP₂₁, LP₁₂, LP₃₁, LP₀₃, LP₀₄, LP₄₁. Techniques for launching these modes and modulating them with optical signals are known. Systems based on transmitting optical signals in multiple modes simultaneously in the same waveguide are referred to here as Mode Division Multiplexed (MDM) systems. The wavelength(s) for the multiple may be the same or very closely spaced. In the latter case, the wavelengths will typically be spaced by 30 nanometers or less. The wavelength sources are typically lasers.

It should be evident from the foregoing discussion that the pairs of optical fibers are few mode fibers supporting fewer than ten propagating modes. The use of the term supporting is intended to mean that at least 10% of the optical energy propagating for a distance of at least 10 meters has the given mode number.

Various other modifications of this invention will occur to those skilled in the art. All deviations from the specific teachings of this specification that basically rely on the principles and their equivalents through which the art has been advanced are properly considered within the scope of the invention as described and claimed.

1. An optical fiber transmission span comprising at least one pair of optical fibers optically coupled wherein a first optical fiber of the pair comprises a length (Sₚ) of positive DGD coefficient (Dₚ) optical fiber and the second optical fiber of the pair comprises a length (Sₙ) of negative dispersion coefficient (Dₙ) optical fiber.

2. The optical fiber transmission span of claim 1 wherein:
Sₚ×Dₚ=DGDₚ
Sₙ×Dₙ=DGDₙ and

|DGDₜ|<|DGDₚ|, or <|DGDₙ|

3. The optical fiber transmission span of claim 1 wherein:
Sₚ×Dₚ=Sₙ×Dₙ

4. The optical fiber transmission span of claim 1 wherein Sₚ and Sₙ are equal.

5. The optical fiber transmission span of claim 1 wherein Sₚ and Sₙ are not equal.

6. The optical fiber transmission span of claim 1 wherein the pair of optical fibers are few mode fibers supporting fewer than ten propagating modes

7. The optical fiber transmission span of claim 6 wherein the pair of optical fibers supports LP₀₁ and LP₁₁.

8. Apparatus to transmit in a single Mode Division Multiplexed (MDM) waveguide a modulated optical signal in a first optical mode simultaneously with a modulated optical signal in a second optical mode comprising:
a first input waveguide for the modulated optical signal in the first optical mode coupled to the MDM waveguide,
a second input waveguide for the modulated optical signal in the second optical mode coupled to the MDM waveguide,
wherein the MDM waveguide comprises:
at least one pair of optical fibers optically coupled wherein a first optical fiber of the pair comprises a length (Sₚ) of positive DGD coefficient (Dₚ) optical fiber and the second optical fiber of the pair comprises a length (Sₙ) of negative dispersion coefficient (Dₙ) optical fiber.

9. The apparatus of claim 8 wherein:
Sₚ×Dₚ=DGDₚ
Sₙ×Dₙ=DGDₙ and

|DGDₜ|<|DGDₚ|, or <|DGDₙ|

10. The apparatus of claim 8 wherein:
Sₚ×Dₚ=Sₙ×Dₙ

11. The apparatus of claim 8 where the first input waveguide supports LP₀₁.

12. The apparatus of claim 11 where the second input waveguide supports LP₁₁.

13. The apparatus of claim 8 further including a first optical source for producing the first optical mode and a second optical source for producing the second optical mode.

14. The apparatus of claim 13 wherein the first optical source for producing the first optical mode and the second optical source for producing the second optical mode produce the same wavelength.

15. The apparatus of claim 13 wherein the first optical source for producing the first optical mode and the second optical source for producing the second optical mode produce different but closely spaced wavelengths.

16. The optical fiber cable of claim 8 wherein the second optical fiber of the pair is coupled to the input of an optical fiber amplifier.

17. A method for transmitting in a single Mode Division Multiplexed (MDM) waveguide a modulated optical signal in a first optical mode simultaneously with a modulated optical signal in a second optical mode comprising the steps of:
coupling the first modulated optical signal in the first optical mode to the MDM waveguide,
coupling the second modulated optical signal in the second optical mode to the MDM waveguide,
wherein the MDM waveguide comprises: at least one pair of optical fibers optically coupled wherein a first optical fiber of the pair comprises a length (Sₚ) of positive DGD coefficient (Dₚ) optical fiber and the second optical fiber of the pair comprises a length (Sₙ) of negative dispersion coefficient (Dₙ) optical fiber.

18. The method of claim 17 wherein the DGD coefficients of the pair of optical fibers are chosen to produce a residual DGD with a predetermined sign, and the final optical fiber in the final pair has a DGD with sign opposite to the predetermined sign.

19. The method of claim 18 including the steps of:
measuring the DGD of the MDM waveguide, and
cutting the length of the final optical fiber to compensate for the residual DGD.
